(19) United States
(12) Patent Application Publication
(10) Pub. No.: US 2015/0144481 A1
(43) Pub. Date: May 28, 2015

(54) Production of BN-Composite Materials

(71) Applicant: Auckland Uniservices Limited, Auckland (NZ)

(72) Inventors: Ron Etzion, Auckland (NZ); Grant Jason McIntosh, Auckland (NZ); James Bernard Metson, Auckland (NZ); Mark Ian Jones, Auckland (NZ)

(73) Assignee: Auckland Uniservices Limited, Auckland (NZ)

(21) Appl. No.: 14/404,777

(22) PCT Filed: May 30, 2013
(86) PCT No.: PCT/NZ2013/000091

§ 371 Date: Dec. 1, 2014

(30) Foreign Application Priority Data
May 30, 2012 (NZ) 600341

(51) Int. Cl. C25C 3/08; C04B 41/50; C04B 41/85

(52) U.S. Cl. CPC C25C 3/08; C04B 41/85; C04B 41/5064
USPC 204/242; 427/58; 428/307.7

(57) ABSTRACT

The invention comprises a process comprising infiltrating or infiltrating and coating a substrate with a boron-comprising precursor, and contacting the boron-comprising precursor with a nitrogen-comprising reactant to convert the boron-comprising precursor to BN or other a boron-nitrogen reaction product in the surface porosity or in the surface porosity and on the surface of the substrate. Composite materials comprising as one phase a substrate and BN or other a boron-nitrogen reaction product as a further phase, in surface porosity or in surface porosity and on a surface of the substrate, are claimed.

### FIELD OF INVENTION

The invention relates to a process for producing BN-containing materials suitable for refractory use and which may have other application(s), and to the materials so produced.

### BACKGROUND OF THE INVENTION

The lifetime of an aluminium reduction cell is of great importance economically, not only from the cell material costs standpoint, but also in reducing production downtime and waste generated from cell cut-out and relining. Currently, the lifetime of a cell is constrained by the life of the cathode and sidewall lining refractories.

With continuous improvement of cathode performance, higher demands are placed on a wear resistance of the sidewall material. Higher current cells require materials with higher corrosion resistance, thermal conductivity, and reduced dimensions to increase the cell cavity to accommodate bigger anodes. SiC-based materials are suited to duty as sidewall refractories, the nitride bonded and silicon carbide bonded materials demonstrating superior performance compared to traditional carbon-based lining due to a combination of thermal conductivity, electrical insulation, oxidation resistance and mechanical strength. Nitride bonded SiC materials (SNBSC) provide the current benchmark in large reduction cell application. However, SNBSC blocks undergo degradation during cell operation, particularly in the absence of a protective frozen ledge, which exposes the sidewall to molten electrolyte and gaseous atmosphere above bath level.

Failure of the sidewall material can occur due to various mechanisms, such as abrasion and erosion as a result of magneto-hydrodynamic metal/bath movements. In addition, the sidewall material is subjected to different environments of molten metal, cryolite bath and corrosive gases inside the cell, and oxidation and chemical corrosion of the sidewall material can occur from reaction with these different cell environments. Many factors contribute to the degradation of Si₃N₄ bonded SiC as a sidewall material. Among these, high porosity, high binder content, and high α/β-Si₃N₄ ratio have been identified as having a significant contribution to corrosion rate. Porosity provides access to the bath, which can penetrate into the sidewall material and enhance the oxidation of the binder phase. In addition high porosity allows gaseous attack on the bath-soaked surface of the brick, leading to production of volatile species and degradation. The binder phase is thermodynamically less stable than the SiC grains in the gaseous environment of the cell, hence, excessively high or too low binder content can lead to higher degradation.

Consequences of sidewall degradation are contamination of the produced metal with silicon, leading to production of lower grade product. Further sidewall degradation can cause leakage of molten bath, through the sidewall into the metal shell (tap-out), requiring shut down and cell reconstruction.

To overcome the problem of a weak binder a new material uses SiC as a binder—reaction bonded silicon carbide (RBSC)—was introduced to the market recently, as a sidewall material for aluminium reduction cells. However, while this material does not incorporate the less thermodynamically stable silicon nitride, its corrosion rate is higher than SNBSC material (in lab-scale reduction tests).

### SUMMARY OF INVENTION

The invention provides a process for economically producing refractory materials and which may have other application(s).

In broad terms in one aspect the invention comprises a process comprising:
infiltrating or infiltrating and coating a substrate with a boron-comprising precursor, and
contacting the boron-comprising precursor with a nitrogen-comprising reactant to convert the boron-comprising precursor to BN and/or other a boron-nitrogen reaction product(s) in the surface porosity or in the surface porosity and on the surface of the substrate.

In broad terms in another aspect the invention comprises a composite material comprising as one phase a substrate and BN and/or other a boron-nitrogen reaction product(s) as a further phase, in surface porosity or in surface porosity and on a surface of the substrate.

Typically the substrate is a ceramic material. In some embodiments the substrate comprises a carbide material such as an SiC (including RBSC), BC, WC. In other embodiments the substrate comprises a nitride material, such as Si₃N₄, AlN. The substrate may itself comprise a composite material comprising for example a carbide and a nitride, such as an Si₃N₄—SiC composite material such as SNBSC for example. Alternatively the substrate material may be a graphitic material, or other carbon-based material.

In some embodiments the boron-comprising precursor comprises a borate such as borax or a sodium borate, boric acid (H₃BO₃), a boric oxide, or other boron salt, in an aqueous or an organic solvent. In some embodiments the boron-comprising precursor may be infiltrated together with a nitrogen source such as a urea for example.

In some embodiments the nitrogen-comprising reactant comprises ammonia or a urea. In some embodiments nitriding is carried out by exposing the substrate to ammonia or nitrogen gas, the latter particularly where for example the boron-comprising precursor solution also comprises urea.

Nitriding may be carried out at elevated temperature, such as a temperature above about 500 C, but less than about 1300 C when the nitrogen-comprising reactant is ammonia.

The nitriding converts the boron-comprising precursor to BN and/or other a boron-nitrogen reaction product(s) such as B O N (boron oxy nitride) in the surface porosity or in the surface porosity and on the surface of the substrate.

The process may include after the steps of infiltrating or infiltrating and coating with a boron-comprising precursor and then contacting with a nitrogen-comprising reactant to convert the boron-comprising precursor to a boron-nitrogen reaction product in the surface porosity or in the surface porosity and on the surface of the substrate, then one or more repeated cycles of the same steps on the substrate, to further reduce the porosity and/or increase the corrosion resistance of the substrate for example.

The process may include a further step of subsequently annealing the nitrided (herein: BN infiltrated) material, to convert at least some and preferably a major fraction of the BN or other a boron-nitrogen reaction product(s) from an amorphous to a crystalline state.

The boron-comprising precursor may be infiltrated into surface open porosity of the substrate, or both infiltrated into surface porosity and coat the surface of the substrate.

Materials of the invention prepared by the process of the invention have reduced porosity relative to the substrate material, and/or the porosity is substantially closed at the substrate surface, by an infiltrate or coating having relatively high corrosion resistance. Materials of the invention may be suitable as refractory materials for example, for use in electrolytic reduction cell linings and for other application(s). High density SiC-based refractory materials can be manufactured via sintering or hot isostatic pressing, but these materials tend to be expensive and not suitable for a large scale production such as the refractory industry. The process of the invention may enable economic densification of cheaper RBSiC and SNBSC materials.

The term “comprising” as used in this specification and claims means “consisting at least in part of”. When interpreting statements in this specification and claims which include the “comprising”, other features besides the features prefaced by this term in each statement can also be present. Related terms such as “comprise” and “comprised” are to be interpreted in similar manner.

### BRIEF DESCRIPTION OF THE FIGURES

In the accompanying figures:

FIGS. 1a and b are photographs of a RBSiC sample BN infiltrated by the process of the invention, and an uncoated RBSiC sample;

FIG. 2 shows XRD patterns of a semi-pure BN material, prior to and following thermal annealing, produced by one variant of the invention;

FIG. 3 is the XRD pattern of pure, crystalline BN powder scraped off BN-coated RBSiC from an optimized version of the invention;

FIG. 4 shows reflectance IR spectra BN powders produced in two variants of the invention;

FIGS. 5a and b are an SEM overview of the exterior of a BN—RBSiC sample and a higher magnification image, respectively;

FIGS. 6a and b are an SEM overview and higher magnification interior cross-sections of an H₃BO₃-infiltrated RBSiC sample following nitridation;

FIGS. 7a and b show B 1s and N 1s XPS spectra of BN material adhered to the exterior face of a BN-impregnated RBSiC sample;

FIGS. 8a and b, and c and d, show respectively B 1s and N 1s XPS spectra of BN materials deposited along the outside edge of a RBSiC sample brick, and in the core of the same sample;

FIG. 9 is a photograph of a first batch of corroded samples from polarized corrosion experiments; and

FIG. 10 is a photograph of a second batch of corroded samples from polarized corrosion experiments.

FIG. 11 is a photograph of SNBSC and BN—SNBSC samples following a more aggressive polarized corrosion experiment.

### DETAILED DESCRIPTION

As stated the process of the invention comprises infiltrating the surface porosity of a substrate material or phase with a boron-comprising precursor and then a nitrogen-comprising reactant to convert the boron-comprising precursor to BN and/or other a boron-nitrogen reaction product(s) within and/or over the surface porosity of the substrate, to reduce or close the surface porosity with and provide a relatively high corrosion resistant material.

The substrate if for use in a reduction cell lining for example may be any non- or low-electrically conductive high temperature material, and typically will be a refractory material, such as a ceramic material including but not limited to carbides such as silicon carbide including reaction bonded silicon carbide, boron carbide, or tungsten carbide, or nitrides such as silicon nitride or aluminium nitride, or a composite such as silicon nitride bonded silicon carbide. Alternatively the substrate may be a graphite-based or other carbon-based material.

The process comprises first infiltrating surface porosity of the substrate with the boron-containing precursor, by liquid infiltration. Typically the infiltrate solution is a saturated solution of the boron precursor. The boron precursor is preferably completely dissolved in the solution without suspended material, preferably as a super saturated solution. The solution can be prepared by for example stirring excess salt precursor. The boron precursor can for example be boric acid, borax, boric oxide, or a mixture such as particularly a 1:1 mixture of boron oxide:and borax which optimizes solubility in water. In addition a nitrogen source can optionally be added to the infiltrate solution. For example urea can be added to the infiltrate solution as both a source of nitrogen for the nitridation step and to increase the solubility of the boron precursor in the solution. A 1:1:2 (w/w) mixture of boric acid:borax:urea in water prepared with gentle heating (˜60° C.) leads to a solution (192 g of total dissolved solids in 100 mL of solvent is achievable) with a highly concentrated boron-source component and also containing a nitrogen source.

The solvent can be an aqueous solvent, or alternatively a simple alcohol such as methanol and ethanol, which are good solvents for boric acid (the solubility tends to decrease in higher alcohols). A boric acid-borax system has good solubility in water, comparable to boric acid solubility in methanol.

The prepared solution is preferably left to equilibrate, and then any un-dissolved materials filtered out. The infiltrate solutions may be prepared at room temperature, but heating may increase solubility of the boron and nitrogen precursors, and the infiltration depth of the infiltrate solution. Typically aqueous salt solutions are usable from about ˜20 to about 100° C.

Before infiltration the substrate may be heated, which may expand surface pores of the substrate and/or prevent cooling on contact of the infiltrate solution, which may lead to early salt deposition of the infiltrate solution.

Preferably pressure or vacuum infiltration, particularly vacuum infiltration, is used to aid deep infiltration below the substrate surface. However infiltration may be by dipping or immersing the substrate or at least one surface thereof in the infiltrate solution, or alternatively spraying the infiltrate solution heavily onto the substrate for example. The solvent can then be left to dry. Drying can be aided by heating the substrate, which also enhances salt accessibility into the deep porosity.

The substrate, filled and optionally also coated with the boron precursor salt, is then nitrided, for example under flowing ammonia (NH₃) or nitrogen at elevated temperature, such as a temperature above 500 C. Temperatures as low as ˜500° C. can lead to conversion to boron nitride (BN) and/or other a boron-nitrogen reaction product(s) however the reaction is slow and yields a relatively lower conversion rate. When the nitrogen-comprising reactant also comprises ammonia or urea, nitriding may be carried out at less than about 1300° C. such as temperatures is in the range about 850-900° C., to avoid thermal decomposition of the ammonia and potential evaporation of unreacted boron precursor salt. Conversely, if urea or other nitrogen source such as biuret, guanidine, cyanamide, dicyanamide, thiourea, or melamine for example is co-deposited in the pores and/or coated on the substrate surface, heating in an inert atmosphere or, preferably, anhydrous NH₃ under similar conditions will also lead to BN and/or other a boron-nitrogen reaction product(s) production. The use of both nitrogen as a ntirding gas and NH₃ in the boron precursor solution is preferred as the gas will nitride the most exposed surface salt deposits while the co-deposited nitrogen source enables reaction to BN and/or other a boron-nitrogen reaction product(s) within the pores, and the excess NH₃ can drive nitridation to completion.

The substrate such as a refractory brick for example may be treated on one or multiple surfaces or sides thereof. Elements or parts may be treated on both external and internal surfaces for example.

The process may include one or more repeated cycles of the same steps of infiltrating or infiltrating and coating with a boron-comprising precursor and then contacting with a nitrogen-comprising reactant to convert the boron-comprising precursor to a boron-nitrogen reaction product in the surface porosity or in the surface porosity and on the surface of the substrate, on the substrate, to further reduce the porosity and/or increase the corrosion resistance of the substrate for example.

Optionally the material may then be subjected to thermal annealing and crystallization of the product, by simple thermal annealing under an inert atmosphere (nitrogen, or argon), typically at 1500° C. or above but preferably not exceeding 1800° C., typically for at least an hour.

### EXPERIMENTAL

The invention is further illustrated by way of example, by the following description of experimental work:

### Method

A first sample set, hereafter referred to as small-scale samples, were 15×15×25 mm³ sized refractory samples were boiled in 30-40 g boric acid per 100 mL methanol solutions for 1 hr, and then left until the solvent had dried, encasing the samples in boric acid. These samples were subsequently nitrided by sealing them in a horizontal tube furnace along with ˜5 g of urea, and heating to 890° C. for 4 hr under flowing nitrogen.

A second sample set, hereafter referred to as ‘corrosion test scale samples’, were 165×15×25 mm³ sized refractory samples, and were infiltrated with a highly concentrated infiltrate solution comprising 48 g boric acid, 48 g borax, and 96 g urea in 100 mL water, prepared by mixing the reagents/solvent, and heating to ˜60° C. until dissolved. Upon cooling, a stable highly saturated solution was obtained. The samples were vacuum infiltrated with this infiltrate, and then boiled until the solvent had been removed (at which point the infiltrate is molten). The encased samples were nitrided at 950° C. for 3 hr in a horizontal tube furnace under flowing NH₃.

All samples were soaked in water for several hours to remove unreacted reagent prior to analysis.

### Results

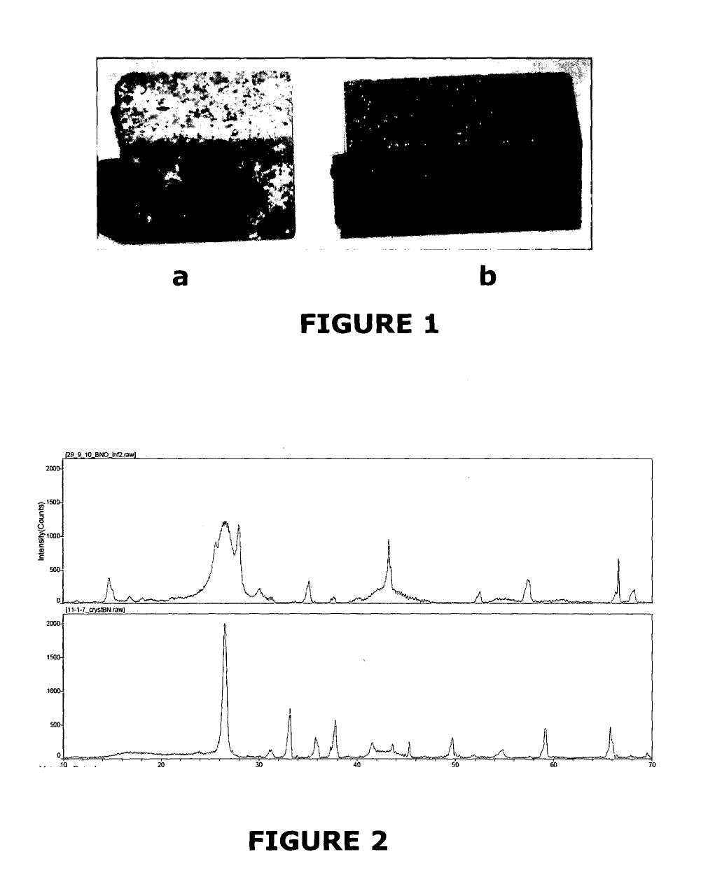

Physical appearance: FIGS. 1a and 1b show respectively BN-coated and uncoated small-scale RBSiC samples. The untreated material is dark grey (the binder), with flecks of grey-black (the SiC grains), typically a few millimetres in size. Post-BN deposition, the samples have a noticeable white material adhered to the surface; on close inspection, white deposits also appear in the visible porosity. Corrosion-testing scale samples appear very similar, although all faces are BN coated in this treatment.

Bulk physical properties: The open porosity in the untreated substrates is variable, but typically 12-16%. BN coating by the process of the invention can lower porosity by a third, repeated cycles have more than halved the open porosity, and corrosion-testing sized rods with porosities as low as 6% have been produced.

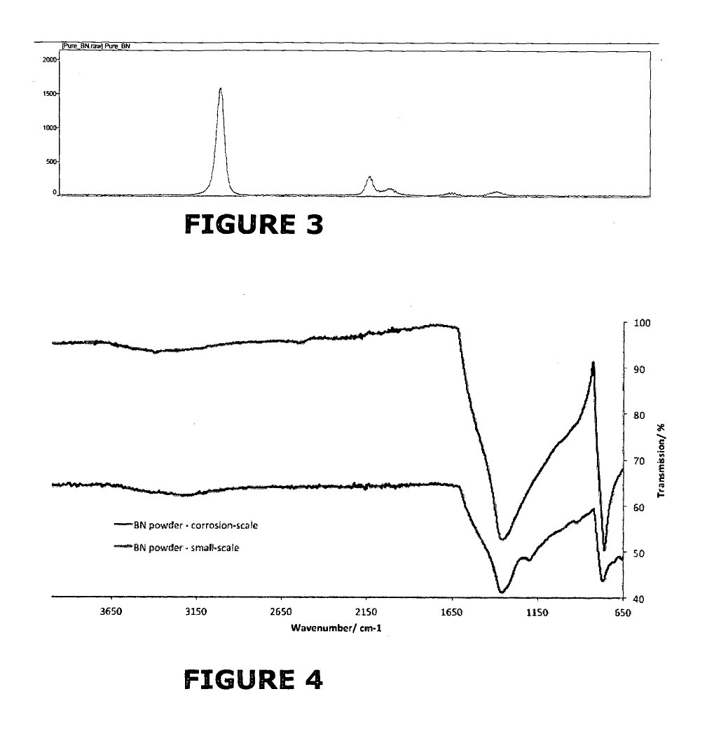

Microstructural features and distribution of BN: XRD is a useful means of confirming the presence of BN. However, BN is relatively insensitive in XRD when compared to SiC and Si₃N₄, and detection of BN inside the pores with XRD is difficult. Consequently, XRD patterns pertain only to powders removed from the exterior of treated refractory samples. FIG. 2 (top) and (bottom) are XRD patterns of BN powder from RBSiC both prior to, and following, thermal annealing at 1700° C. respectively. The latter figure indicates that simple thermal annealing under an inert atmosphere is sufficient to convert to a crystalline BN product (as indicated by the narrowing of peaks). There are some impurities present in these materials as noted upon comparison with FIG. 3 which depicts the XRD pattern of material from corrosion-testing scale samples and corresponds to the pattern of pure BN. FIG. 3 also demonstrates that a correctly optimized infiltration process can yield a crystalline material without a secondary thermal annealing step.

Reflectance FT-IR measurements on the powders analyzed with XRD similarly confirm the formation of BN, at least as a coating, with characteristic BN peaks appearing at 1369 and 772 cm⁻¹. FIG. 4 shows reflectance IR spectra of small-scale and corrosion-testing scale samples.

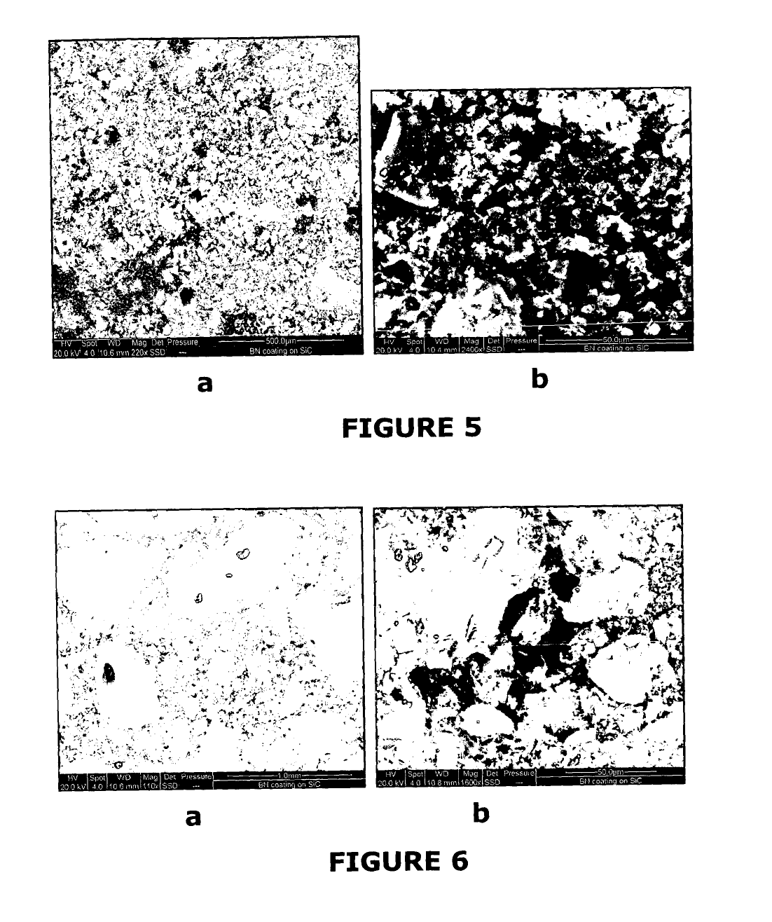

Scanning Electron Microscopy (SEM) provides visual evidence for the presence of boron both coating and dispersed throughout the pores of small-scale test bricks. FIG. 5a is an SEM overview of the exterior of a BN—RBSiC sample. Boron appears dark grey/black. FIG. 5b is a higher magnification image and shows deposits in the pore structure.

FIGS. 6a and b show interior cross-sections of small-scale RBSiC samples following nitridation. FIG. 6a is an overview and FIG. 6b is a higher magnified view of the binder phase indicating an abundance of boron-rich deposits. This image is focused in the centre of the test piece and represents the core of the sample. These images show that a penetration depth of at least ˜0.8 mm.

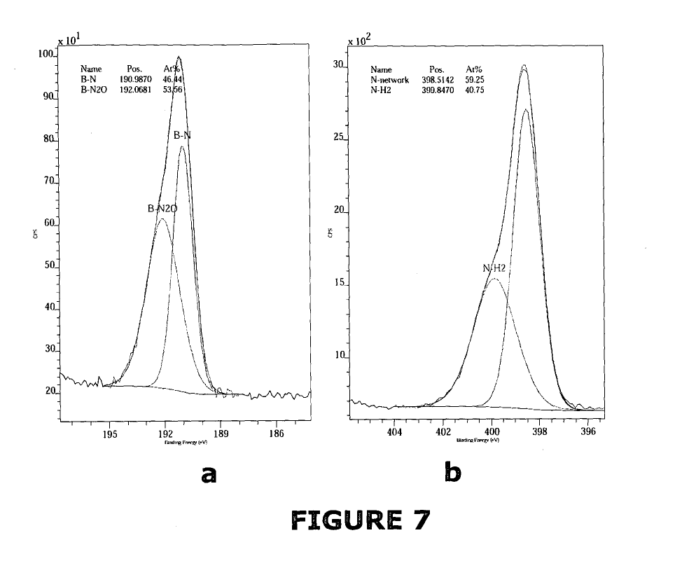

FIG. 7 shows XPS analyses of the exterior surface of a small-scale BN—RBSiC sample. FIG. 7a shows B 1s and FIG. 7b shows N 1s peaks from XPS spectra of BN material adhered to the exterior face of a BN-impregnated RBSiC sample. These analyses show the presence of BN adhered to the exterior of the sample

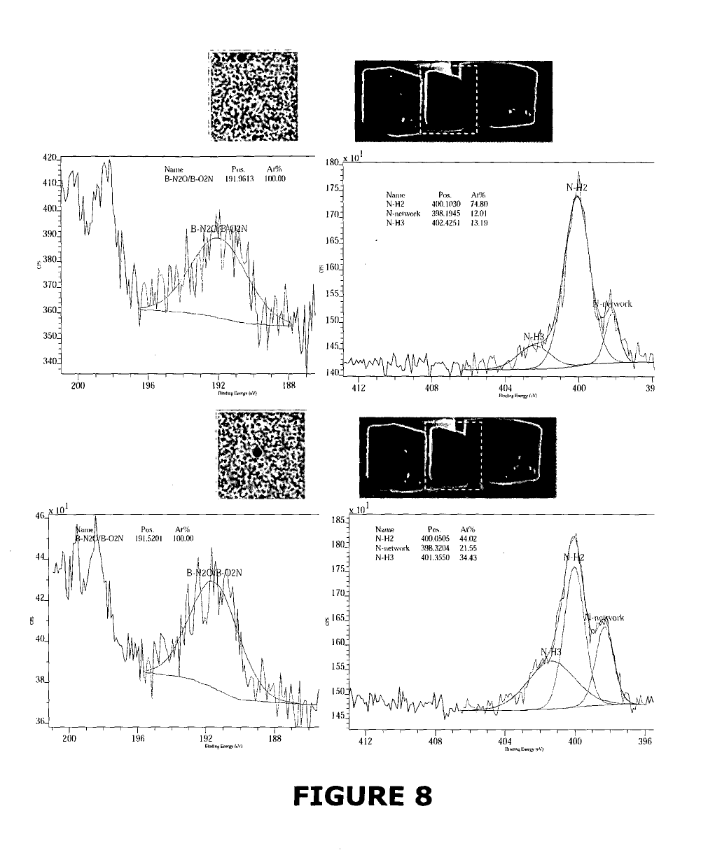

FIG. 8 shows XPS analyses performed in the deep core of the sample of FIG. 7. FIGS. 8a and b (top) and c and d (bottom) shows respectively B 1s and N 1s XPS spectra of BN materials deposited along the outside edge of a 15×15×25 mm RBSiC sample brick, and in the core of the same sample. The spectra indicate the presence of boron oxynitrides. The B 1s peaks indicate this material contains some B—N₂O and B—NO₂ environments; this, in conjunction with the NH₂ and NH₃ environments seen in the N 1s peaks indicates incompletely nitrided materials deep in the core. But, N_{network} (associated with nitrogen atoms bonded in some extended solid-state network) peaks also unambiguously show the presence of BN. These analyses show that BN, and partially nitrided boron oxide-based materials, are formed in the pores of SiC based refractories.

Comparative corrosion resistance properties of SiC and BN SiC refractory materials: Corrosion resistance was tested in a laboratory-scale aluminium reduction cell on the corrosion-testing scale samples. The tests were carried out at 1000° C. to simulate worst-case scenarios to provide accelerated materials corrosion. Typically, visual observation is informative; however volume changes can also be recorded in order to provide more quantitative (and therefore less subjective) data. SNBSC, BN—SNBSC, RBSiC, and BN—SNBSC samples were tested simultaneously.

The volume change results for an initial test set are given in Table 1 below. BN—SNBSC considerably outperformed SNBSC. BN—RBSiC, at 1.60% volume loss, also outperformed SNBSC (the current industrial gold-standard) at 1.96%; multiple previous tests on untreated materials have shown that SNBSC invariably outperforms RBSiC. Both results indicate considerable corrosion-resistance enhancements in the BN-treated materials. Visual inspection of the sample indicated the sample was so heavily corroded, especially at the molten bath-air interface, that it fractured during the experiment. This fracturing tends to lead to overestimates in the volume, and therefore under-represents the volume change achieved.

TABLE 1
Volume change data for the first batch of corrosion-
tested SiC-based refractory samples

| | SNBSC | BN-SNBSC | RBSiC | BN-RBSiC |
|---|---|---|---|---|
| ΔV/cm³ | −0.65 | −0.28 | −0.95 | −0.69 |
| ΔV/% | −1.96 | −0.73 | −2.18 | −1.60 |

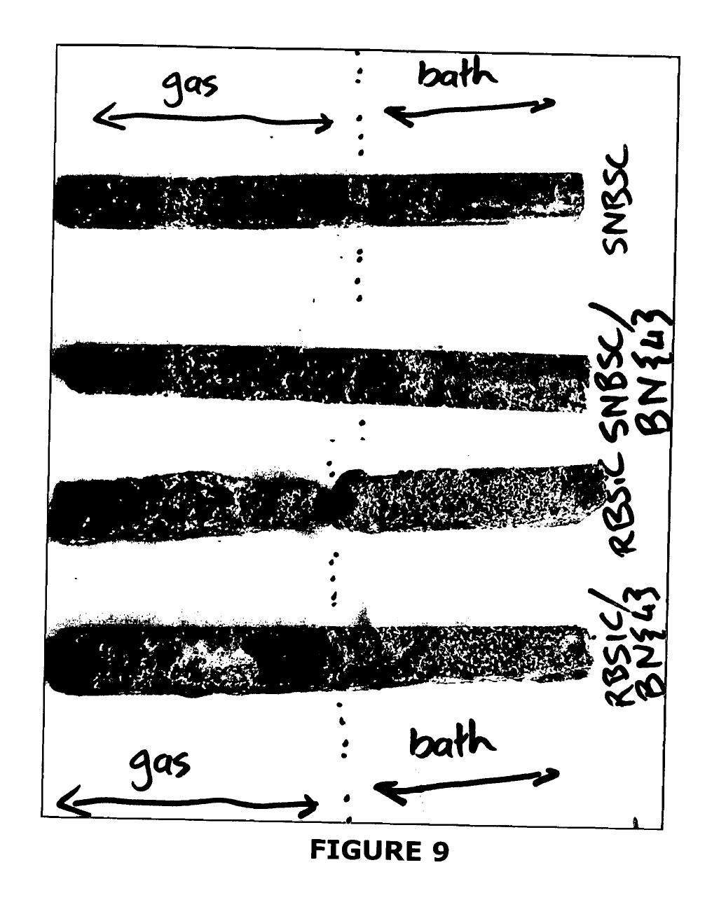

FIG. 9 is a photograph of a first batch of corroded samples from polarized corrosion experiments.

These tests were replicated with slightly more heavily treated samples. Volume changes are listed in Table 2 below. The data for the RBSiC-based samples are listed in italics as unfortunately sample fracturing unrelated to the corrosion tests occurred making the volume loss data unreliable. Further, the volume loss data obtained for the SNBSC samples was very low—the small volume losses indicate that neither sample underwent significant enough degradation to reliably rank these materials (the volume differences are low enough that experimental errors are significant). Therefore, visual inspection provides the most reliable assessment of the second batch of samples.

TABLE 2
Volume change data for the second batch of corrosion-
tested SiC-based refractory samples.

| | SNBSC | BN-SNBSC | RBSiC | BN-RBSiC |
|---|---|---|---|---|
| ΔV/cm³ | −0.33 | −0.63 | −1.26 | −2.02 |
| ΔV/% | −0.23 | −0.54 | −0.68 | −1.48 |

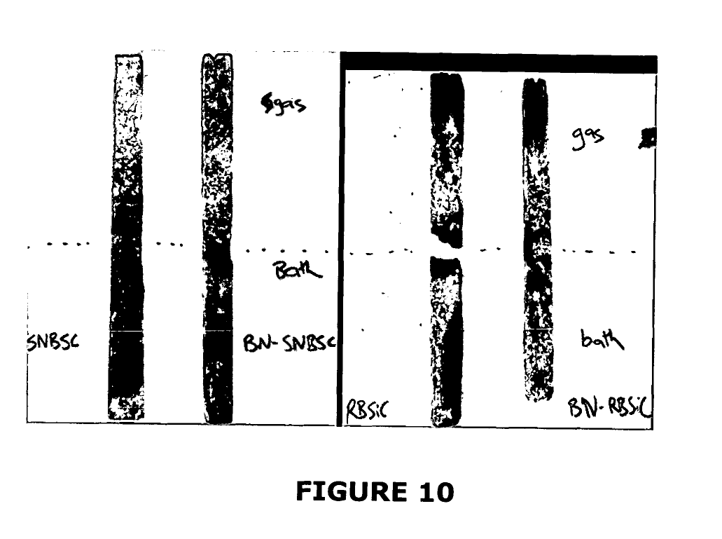

FIG. 10 is a photograph of the second batch of corroded samples from polarized corrosion experiments. The two SNBSC samples are corroded to a similar extent—this is in line with the results of Table 2. The bottom of the BN—SiC sample lost some shape, however the rest of the BN—SiC sample held up comparably well. The untreated RBSiC sample, however, again fractured during the corrosion test, indicating severe degradation.

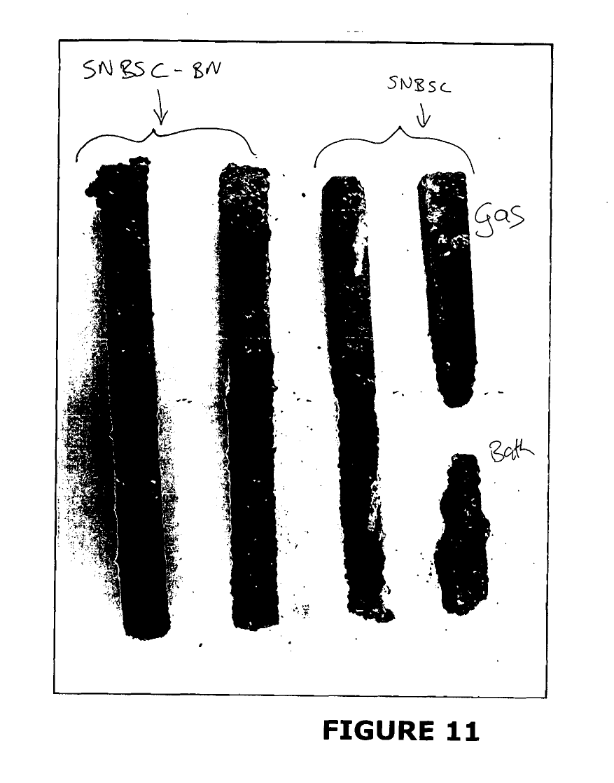

Finally, given the closeness of the results achieved with BN—SNBSC and SNBSC samples, a more aggressive testing regime was trialled by employing a less corrosion resistant SNBSC brick (there is a degree of corrosion resistance variability inherent in this product). FIG. 11 depicts the corrosion testing results of these trials. This sample set very conclusively demonstrates that substantial gains in corrosion resistance are made with BN-treatment of refractory bricks.

1. A process comprising:
infiltrating or infiltrating and coating surface porosity of a substrate with a boron-comprising precursor, and
contacting the boron-comprising precursor with a nitrogen-comprising reactant to convert the boron-comprising precursor to a boron-nitrogen reaction product in the surface porosity or in the surface porosity and on the surface of the substrate.

2. A process comprising:
infiltrating or infiltrating and coating surface porosity of a substrate with a boron-comprising precursor, and
contacting the boron-comprising precursor with a nitrogen-comprising reactant to convert the boron-comprising precursor to BN in the surface porosity or in the surface porosity and on the surface of the substrate.

3. A process according to claim 1 wherein the substrate is a ceramic material.

4. A process according to claim 2 wherein the substrate comprises a carbide material.

5. (canceled)

6. A process according to claim 2 wherein the substrate comprises a nitride material.

7. (canceled)

8. A process according to claim 2 wherein the substrate comprises a carbide-nitride composite material.

9. A process according to claim 8 wherein the substrate comprises a silicon nitride bonded silicon carbide material.

10. A process according to claim 1 wherein the boron-comprising precursor comprises a borate.

11. (canceled)

12. A process according to claim 1 wherein the boron-comprising precursor is infiltrated together with a nitrogen source.

13. (canceled)

14. A process according to claim 1 wherein the nitrogen-comprising reactant comprises ammonia or nitrogen.

15. A process according to claim 14 including contacting the boron-comprising precursor with the nitrogen-comprising reactant by contacting the substrate infiltrated with the boron-comprising precursor, with flowing ammonia or nitrogen gas.

16. A process according to claim 1 including contacting the boron-comprising precursor with the nitrogen-comprising reactant at a temperature above 500 C.

17. (canceled)

18. A process according to claim 1 including subsequently annealing the substrate to convert at least some of the boron-nitrogen reaction product to a crystalline state.

19. (canceled)

20. A composite material comprising a substrate phase comprising BN or other boron-nitrogen reaction product in surface porosity or in surface porosity and on a surface of the substrate phase, reducing the surface porosity of the composite material relative to that of the substrate phase.

21. A composite material according to claim 20 wherein the substrate is a ceramic material.

22. A composite material according to claim 20 wherein the substrate comprises a carbide material.

23. A composite material according to claim 21 wherein the substrate comprises SiC (including RBSC), BC, or WC

24. A composite material according to claim 20 wherein the substrate comprises a nitride material.

25. A composite material according to claim 24 wherein the substrate comprises Si₃N₄ or ACN.

26. A composite material according to claim 20 wherein the substrate comprises a carbide-nitride composite material.

27. A composite material according to claim 26 wherein the substrate comprises a silicon nitride bonded silicon carbide material.

28. A process comprising:
infiltrating or infiltrating and coating surface porosity of substrate material comprising a carbide, nitride, or a carbide-nitride composite with a boron-comprising precursor solution also comprising a nitrogen source, and
contacting the boron-comprising precursor with a nitrogen-comprising reactant at elevated temperature to convert the boron-comprising precursor to a boron-nitrogen reaction product comprising BN and/or other boron-nitrogen reaction product(s) in the surface porosity or in the surface porosity and on the surface of the substrate to reduce the surface porosity of the substrate.

29. A process according to claim 28 including after said steps of infiltrating or infiltrating and coating with a boron-comprising precursor and contacting with a nitrogen-comprising reactant to convert the boron-comprising precursor to a boron-nitrogen reaction product in the surface porosity or in the surface porosity and on the surface of the substrate, repeating said same steps on the substrate.

30. A composite material comprising a carbide, nitride, or a carbide-nitride substrate phase comprising BN and/or other boron-nitrogen reaction product(s) in surface porosity or in surface porosity and on a surface of the substrate phase.

31. An electrolytic reduction cell comprising a sidewall material according to claim 20.

32. (canceled)

33. A process according to claim 2 wherein the substrate comprises a carbide material.

34. A process according to claim 33 wherein the substrate comprises SiC (including RBSC), BC, or WC.

35. A process according to claim 2 wherein the substrate comprises a nitride material.

36. A process according to claim 35 wherein the substrate comprises Si₃N₄ or AlN.

37. A process according to claim 2 wherein the substrate comprises a carbide-nitride composite material.

38. A process according to claim 37 wherein the substrate comprises a silicon nitride bonded silicon carbide material.

39. A process according to claim 2 wherein the boron-comprising precursor comprises a borate.

40. A process according to claim 39 wherein the boron-comprising precursor comprises borax or a sodium borate, boric acid (H₃BO₃), or a boric oxide.

41. A process according to claim 2 wherein the boron-comprising precursor is infiltrated together with a nitrogen source.

42. A process according to claims 2 wherein the nitrogen-comprising reactant comprises ammonia or nitrogen.

43. A process according to claim 41 including contacting the boron-comprising precursor with the nitrogen-comprising reactant by contacting the substrate infiltrated with the boron-comprising precursor, with flowing ammonia or nitrogen gas.

44. A process according to claim 41 including contacting the boron-comprising precursor with the nitrogen-comprising reactant at a temperature above 500 C.

45. A process according to claim 2 including after said steps of infiltrating or infiltrating and coating with a boron-comprising precursor and contacting with a nitrogen comprising reactant to convert the boron-comprising precursor to a boron-nitrogen reaction product in the surface porosity or in the surface porosity and on the surface of the substrate, repeating said same steps on the substrate.

46. A process according to claim 2 including subsequently annealing the substrate to convert at least some of the BN or other boron-nitrogen reaction product to a crystalline state.
